(19) United States
(12) Patent Application Publication
(10) Pub. No.: US 2005/0016384 A1
(43) Pub. Date: Jan. 27, 2005

(54) HOUSEHOLD COFFEE AND HOT BEVERAGE DISPENSER

(76) Inventor: Gerard Tassinary, Hampton Falls, NH (US)

Correspondence Address: DECKER LAW OFFICE, 1 NEW HAMPSHIRE AVE., SUITE 125, PORTSMOUTH, NH, 03801, US

(21) Appl. No.: 10/710,633

(22) Filed: Jul. 26, 2004

Related U.S. Application Data
(60) Provisional application No. 60/481,146, filed on Jul. 26, 2003.

(51) Int. Cl. A23F 3/00

(52) U.S. Cl. 99/279

(57) ABSTRACT

An apparatus for making single serving brewed coffee and/or powder mixes that is suitable for household use that has a water tank and heater, heated water holding tank, coffee filter and coffee filter holder, dry mix hopper, auger, and a whipping chamber. The entire unit, with its appropriate controls, is sized to fit on a kitchen counter underneath a cabinet.

### BACKGROUND OF INVENTION

1. Field of the Invention.

The invention is related to plural bed or filter type single serving hot beverage dispensers.

2. Description of the Related Art

Although coffee brewing machines have been available for some time, technical challenges exist for combining a household, single-serving coffee brewer with an apparatus for dispensing water-soluble mixes with hot water. The most desirable mixes include, but are not limited to sugar, creamer, instant cappuccino, cocoa or chai mix and the like. One person has tried to solve the problem by dispensing instant coffee instead of brewed coffee, which is disclosed in U.S. Pat. No. 4,066,186, which is not admitted to being prior art by its mention in this Background section. This apparatus merely dispenses the ingredients, but does not combine them with hot water.

Others have created dispensers that dispense hot beverages made by powdered mixes, but without brewed coffee. One such apparatus is disclosed in U.S. Pat. No. 5,927,553, which is not admitted to being prior art by its mention in this Background section. This apparatus dispenses hot beverages made with mixtures of different powdered mixes. However, it also does not have a coffee brewer.

A few have attempted to make an apparatus that has both a coffee brewer and apparatus for dispensing mixes in one unit. An example is taught in U.S. Pat. No. 3,426,670, which is not admitted to being prior art by its inclusion in this Background section. This apparatus is a coin-operated machine that brews single cups of coffee and adds cream and/or sugar. It is an elaborate machine for use by the general public that would not lend itself to household use, due to its size and complexity. Another example is taught in U.S. Pat. No. 6,182,555, which is not admitted to being prior art by its inclusion in this Background section. Although this apparatus brews coffee, the mixes are condensed liquids and not powders, and so are not as commercially available or as convenient to use as powders. Furthermore, the apparatus is a complex machine that is more appropriate for use in a convenience store or cafeteria instead of a home.

What is needed, therefore, is an apparatus for making single serving brewed coffee with or without added powder mixes that is suitable for household use.

### SUMMARY OF INVENTION

An apparatus for making single serving brewed coffee and/or powder mixes that is suitable for household use comprises a water tank and heater, optional heated water holding tank, coffee filter and coffee filter holder, dry mix hopper, auger, and a whipping chamber. The entire unit, with its appropriate controls, is sized to fit on a kitchen counter underneath a cabinet. These and other features, aspects, and advantages of the present invention will become better understood with regard to the following description and accompanying drawings.

### BRIEF DESCRIPTION OF DRAWINGS

FIG. 1 is a cut-away view of an apparatus according to the present invention.

FIG. 2 is a top view of the apparatus.

### DETAILED DESCRIPTION

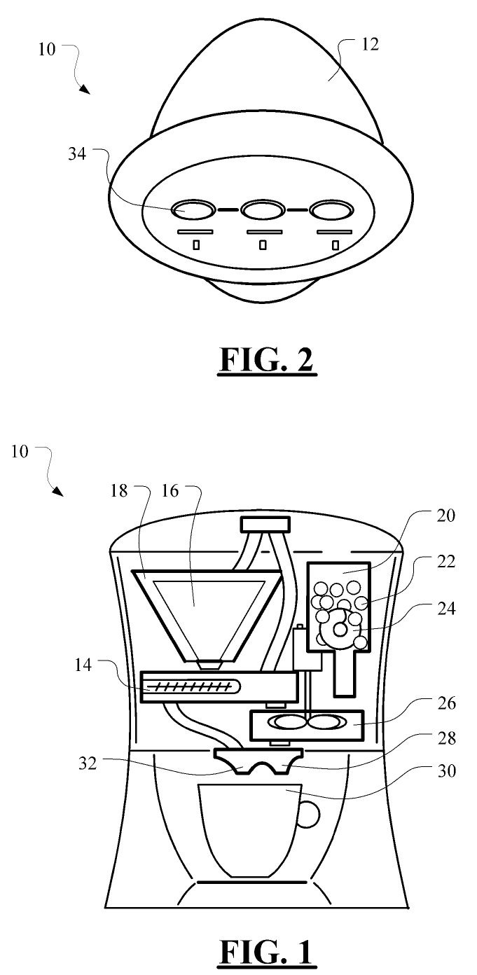

The invention is an apparatus for making single servings of brewed coffee, or single servings of hot beverages made with powdered mixes, or a blend of coffee and powdered mixes, that are suitable for household use. Turning to FIG. 1, the apparatus 10 optionally has a heated holding tank 14 that holds one serving of hot water. The one serving size can be different volumes, and is preferably either about 0.24 liters (eight fluid ounces) or 0.47 liters (sixteen fluid ounces). The heated holding tank 14 holds hot water if a powdered mix alone is selected, or brewed coffee if a combination of brewed coffee and powdered mix is selected. A coffee filter holder 18 is secured over the heated holding tank 14 to hold a removable coffee filter 16 that filters the brewed coffee.

A dry mix hopper 22 is provided for infusing dry mix ingredients into the beverage. The dry mix hopper 22 comprises an opening 20 for the user to spoon in dry mix, for example, sugar, creamer, instant cappuccino, cocoa or chai mix. At an appropriate time in the cycle, an auger 24 disposed near the bottom of the dry mix hopper 22 is activated to move the mix into a whipping chamber 26. The whipping chamber 26 is provided beneath the heated holding tank 14 and the dry mix hopper 22 to perform any or all of several desired functions. First, the whipping chamber 26 mixes the coffee and dry powder to reach a homogeneous blend. Second, the whipping action of the whipping chamber 26 assures that any lumps in the dry mix are broken up before the blend is dispensed into the user's cup 30. Third, the whipping chamber 26 creates a tasty, frothy head for cappuccino, hot chocolate, and similar beverages. It has been found that providing a whipping chamber 26 is necessary for providing a suitable beverage, and is one of the features that distinguish this invention over other beverage dispensers.

FIG. 2 is a top view of the apparatus 10, which shows the preferred arrangement of the water tank and heater 12. Depending on the user's selection, water from the tank 12 travels either to the coffee filter 16, or directly to the holding tank 14.

An important feature of the present invention is that it is suitable for household use. Several features attest to that suitability. First, the entire unit is less than 46 cm (18 inches) in height so that it can fit on a kitchen counter underneath a standard kitchen cabinet. Second, it does not require automatic metering of ingredients like apparatuses found in a convenience store or cafeteria setting. Here, the user adds the coffee grounds and/or dry powder mix. All of the complexity and apparatus for automatic metering is eliminated. Third, with the reduction of size and complexity comes a great decrease in cost, so that the apparatus 10 is affordable to the individual consumer.

There are three modes of operation of the apparatus 10. The user selects the desired mode by pressing buttons 34 labeled for coffee only, powdered mix only, or combination. The buttons communicate with controls for the sequence of powering and operating the water tank 12, heated holding tank 14, auger 24, and whipping chamber 26.

The three modes are described as follows. First is the coffee only mode. In this mode, the user pours the desired amount of water into the water tank 12, and adds ground coffee into the filter 16 disposed within the coffee filter holder 18. The user places a cup 30 under the coffee nozzle 32, and presses the coffee only button, which is likely labeled “COFFEE.” Then, water is heated and passes through the coffee in the coffee filter 16. The coffee passes through the heated holding tank 14, through the coffee nozzle 32 and into the cup 30. The user must remove spent coffee grounds before using the apparatus 10 again.

Second is the powdered mix only mode, which is ideal for making instant cappuccino, cocoa or chai from a mix without brewed coffee. The user pours the desired amount of water into the water tank 12, and adds a measured amount of dry powdered mix into dry mix hopper 22 through the dry mix hopper opening 20. The user places a cup 30 under the whipping chamber nozzle 28, and presses the button 34 corresponding to powdered mix only. The button may be labeled “CAPPUCCINO” or “COCOA” or “CHAI.” The water is then heated and dispensed into the heated holding tank 14, if provided, or directly into the whipping chamber 26 if not. When the heated holding tank is full, the controls activate the dry mix auger 24 that transports the dry mix into the whipping chamber 26. The whipping chamber 26 motor activates, and water flows into the whipping chamber, whipping and blending the beverage. The controls time the cycle so that the auger 24 will have emptied the dry mix hopper 22 when there is still some water in the holding tank 14 to rinse the whipping chamber 26.

Third is the combination mode. The user pours the desired amount of water into the water tank 12. After putting the coffee filter 16 into the coffee filter holder 18, the user adds ground coffee into the filter 16 and dry mix into the dry mix hopper 22 through the opening 20. For example, one would add one to three scoops of cappuccino mix. After placing a cup 30 under both the coffee nozzle 32 and whipping chamber nozzle 28, the user presses the buttons corresponding to dispensing a combination beverage. The buttons 34 may be labeled “CAPPUCCINO/COMBO.” At this time, the water will be heated and dispensed into the ground coffee held within the coffee filter 18, and then brewed coffee will flow into the heated holding tank 14, if provided, or directly to the whipping chamber 26 if not. After all of the coffee has been brewed, the auger 24 will transport the dry mix in the hopper 22 into the whipping chamber 26. Then, a motor will be engaged to activate the whipping chamber 26. The coffee will flow from the holding tank 14 and the dry mix will flow from the hopper 22 to be whipped together. The dry mix hopper 22 will be emptied while the hot coffee is still flowing out of the heated holding tank 14 to rinse the whipping chamber 26 of dry mix.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

1. An apparatus for making at least one of a single serving brewed coffee and powder mix beverage that is suitable for household use comprising a water tank and heater, holding tank, coffee filter holder, dry mix hopper, auger, and whipping chamber.

2. The apparatus of claim 1 further comprising a holding tank.

3. The apparatus of claim 1 further comprising a coffee filter.

4. The apparatus of claim 1 wherein the water tank is adapted to hold one serving of water.

5. The apparatus of claim 1 wherein the dry mix hopper is adapted to hold one serving of a dry mix.

6. The apparatus of claim 1 wherein the apparatus is less than 46 cm in height.

7. The apparatus of claim 2 further comprising controls for controlling the sequence of power and operation of the water tank, holding tank, auger, and whipping chamber.

8. The apparatus of claim 7 further comprising at least one press button in communication with the controls for selecting for making at least one of a single serving brewed coffee and powder mix beverage.

9. The apparatus of claim 8 wherein the controls are adapted to, when single serving brewed coffee is selected,
heat a single serving of water in the water tank,
infuse the heated water into coffee in a coffee filter holder thereby making brewed coffee,
pass the brewed coffee through the heated holding tank, and into a user's cup.

10. The apparatus of claim 8 wherein the controls are adapted to, when powder mix only is selected,
heat a single serving of water in the water tank,
transfer the heated water into the heated water holding tank,
activate the auger to transfer mix to the whipping chamber when the holding tank is full, then
activate the whipping chamber thereby whipping the mix and heated water, and
pass the mix and heated water into a user's cup.

11. The apparatus of claim 8 wherein the controls are adapted to, when a combination coffee and powder mix is selected,
heat a single serving of water in the water tank,
infuse the heated water into coffee in a coffee filter holder thereby making brewed coffee,
pass the brewed coffee into the heated holding tank,
activate the auger to transfer mix to the whipping chamber when the holding tank is full, then
activate the whipping chamber thereby whipping the mix and brewed coffee, and
pass the mix and brewed coffee into a user's cup.

12. An apparatus for making at least one of a single serving brewed coffee and powder mix beverage that is suitable for household use comprising
a water tank in communication with both a coffee filter
holder adapted to hold a coffee filter and a heated water holding tank,
a dry mix hopper having an opening at its top adapted to receive a dry mix, a dry mix auger inside the dry mix hopper,
a whipping chamber below both the heated water holding tank and the dry mix hopper in a spaced relationship to receive heated water from the heated water holding tank and dry mix from the dry mix hopper,
a coffee nozzle below the heated water holding tank adapted for serving a brewed coffee from the heated water holding tank into a user's cup below the coffee nozzle, and
a whipping chamber nozzle below the whipping chamber adapted for serving a dry mix beverage from the whipping chamber into a user's cup below the whipping chamber nozzle.

13. The apparatus of claim 12, further comprising a cabinet for housing the apparatus.

14. The apparatus of claim 13, wherein the cabinet is less than 46 cm in height.

15. The apparatus of claim 13 further comprising controls for controlling the sequence of power and operating of the water tank, holding tank, auger, and whipping chamber.

16. The apparatus of claim 13 further comprising at least one press button in communication with the controls for selecting for making at least one of a single serving brewed coffee and powder mix beverage.

17. The apparatus of claim 13 wherein the controls are adapted to, when single serving brewed coffee is selected,
heat a single serving of water in the water tank,
infuse the heated water into coffee in a coffee filter holder thereby making brewed coffee,
pass the brewed coffee through the heated holding tank, and into a user's cup.

18. The apparatus of claim 13 wherein the controls are adapted to, when powder mix only is selected,
heat a single serving of water in the water tank,
transfer the heated water into the heated water holding tank,
activate the auger to transfer mix to the whipping chamber when the holding tank is full, then
activate the whipping chamber thereby whipping the mix and heated water, and
pass the mix and heated water into a user's cup.

19. The apparatus of claim 13 wherein the controls are adapted to, when a combination coffee and powder mix is selected,
heat a single serving of water in the water tank,
infuse the heated water into coffee in a coffee filter holder thereby making brewed coffee,
pass the brewed coffee into the heated holding tank, activate the auger to transfer mix to the whipping chamber when the holding tank is full, then
activate the whipping chamber thereby whipping the mix and brewed coffee, and
pass the mix and brewed coffee into a user's cup.

20. An apparatus for making at least one of a single serving brewed coffee and powder mix beverage that is suitable for household use comprising
a water tank in communication with both a coffee filter holder adapted to hold a coffee filter,
a dry mix hopper having an opening at its top adapted to receive a dry mix, a dry mix auger inside the dry mix hopper,
a whipping chamber below the dry mix hopper in a spaced relationship to receive heated water from the water tank and dry mix from the dry mix hopper,
a coffee nozzle adapted for serving a brewed coffee into
a user's cup below the coffee nozzle, and
a whipping chamber nozzle below the whipping chamber adapted for serving a dry mix beverage from the whipping chamber into a user's cup below the whipping chamber nozzle.
